(19) United States
(12) Patent Application Publication
(10) Pub. No.: US 2022/0004203 A1
(43) Pub. Date: Jan. 6, 2022

(54) Systems and apparatuses of Personal Aerial Receptacles

(71) Applicant: Daivd Tippet, Jefferson, GA (US)

(72) Inventor: Daivd Tippet, Jefferson, GA (US)

(21) Appl. No.: 16/920,728

(22) Filed: Jul. 5, 2020

(51) Int. Cl. G05D 1/10; B64C 39/02; B64F 1/32; G05D 1/12; G08G 5/00

(52) U.S. Cl. CPC G05D 1/101; B64C 39/024; B64C 2201/128; G05D 1/12; G08G 5/003; B64F 1/32

(57) ABSTRACT

A Personal Aerial Receptacle (PAR) is both a system and an apparatus for safely loading and unloading of items from an unmanned aerial system (UAS) to include packages, US mail, boxes, supplies, food, et al at a business or residential locations. It is the combination of the current postal address and mailbox for UAS delivery.

Current test programs are underway with the Federal Aviation Administration (FAA) and various aerial delivery companies like Google and Amazon. The delivery systems and at present utilize systems that drop off packages at locations that may require human interaction with the UAS where an individual detaches their package from the UAS tether. Other delivery systems may utilize Artificial intelligence to learn where a package could be dropped. Both methods pose unnecessary risk to the home owner, family and unknowing pedestrians pass by when a package is picked up or received. For example, as a package is being lowered gusts of wind may inadvertently sway the tether and it may become lodged making the manual disconnect process impossible. In another case an unsuspecting or uniformed child may try to interfere with the UAS delivery process by touching or crabbing the UAS resulting in serious injury.

Similar to the US postal mailbox for ground-based delivery a receptacle of sorts is needed for safe delivery of and sending of items from UAS's. The Personal Aerial Receptacle (PAR) would provide for safe loading/unloading of packages due to the nature and design of the PAR apparatus. Specifically, a person on the ground could be underneath a safe structure, load a package into the PAR's receptacle and then raise the PAR up and out away from the structure at a height where a UAS would be able to safely and securely place and retrieve an item into and from the receptacle at a location deemed safe and acceptable by the user. PAR's could be safely mounted to columns or railing on front or rear porches and railings on apartment and condominiums.

Current UAS technology relies on a GPS coordinates, a street address to determine a delivery location of a package. Additionally, multiple mail drops may be located on the same property address. The UAS does not have the technology to know where best to drop a package let alone know where to pick up a package. It is conceivable that a precise location could be provided to the package delivery company in advance of the delivery through existing technology by the home or business owner requesting a package. The existing technology, a beacon, could transmit a unique wireless radio frequency or signal from a location of the address owner's choosing. The UAS could use existing passive guidance technology similar to a toll road system locating a car's beacon on a toll road or the pilot of a small plane uses VHF technology to locate final runways of local regional airports. The beacon transmitting a pre-programmed signal could be attached to PAR located at ones residence or business for the purpose of safely receiving and sending packages from a UAS. Once the signal was located by the UAS, the UAS could hover over or rest upon then drop off or pick up a package from the PAR's receptacle that was transmitting the unique signal. The beacon could be solar and or rechargeable battery powered and have a DC powered backup to ensure the beacon's transmission is not interrupted. By the PAR located at a business or home and containing beacon signal the Package delivery company can lower its costs by decreasing the UAS system weight since it would not have a include this technology on the UAS.

The mass produced, molded PAR apparatus would be extendable and retractable in nature using a pull push or scissor like method. The PAR would contain a receptacle at one end that would be used to hold and store items received and retrieved by UAS's. The apparatus would extend out, up and away from and retracted back to the base location either by pulling and pushing of a rope or wench using human or motorized force. The receptacle may be either an open-air like container or be covered where the cover could be opened manually by the UAS or the package recipient or electronically via proximity sensor or other electronic means. The receptacle may be equipped with a light or a series of lights that indicate location, activity, and status of the shipping and receiving process. The PAR would be constructed of non-metallic materials to minimize static electricity and be grounded to avoid lightning strikes. Additional electronic devices could be added to the receptacle to limit access to the owner like OCR, key codes, or bio-metrics. The PAR's base could be stationary or swivel for easier loading and unloading. The Par's base could be mounted to a secure beam, wall or railor be built into a wall and extend through the roof or a house or building. The PAR's main arm or shaft is connected to the Par's base. The base is located at a level where the Par owner can safely place and retrieve packages from the PAR's receptacle. The length of the main arm or shaft should be able to extend up past the structure from which it is mounted such as a gutter or roof on a house or building. A second arm, attached to the main arm or shaft, would extend up and away from the structure. The distance from the structure should ensure the UAS cannot or does not interfere with the structure when dropping and retrieving packages. The receptacle should be large enough to receive packages approved for UAS delivery as determined by law. The PAR should be manufactured to safely support the weight of the PAR and packages shipped and received.

In order for the PAR to be successfully integrated into the UAS delivery process all stakeholders would need to follow a standard set of guidelines. For instance, the home or business owner would be responsible for ensuring that their receptable was in good working order to include that the PAR's signal strength is adequate. In addition, the home or business owner would be responsible for mounting the PAR in a safe and secure location on their property free and clear of obstructions such as buildings, roof lines power lines, shrubbery and trees for ease and safe UAS a delivery and pickup of packages. The home owner would be responsible for personally extending and retracting and/or loading and unloading of PAR and packages as needed. Future enhancements could be added to automate the extending and retracting process and loading and unloading processes. The home or business owner is responsible for sharing the unique identifier with the delivery service providers. The Service Delivery Providers (SDP) would be responsible for integrating the PAR's location technology into their ordering, shipping and receiving processes. The SDP would also be responsible for programming the UAS to interpret the unique identifier and incorporate that signal into the UAS;s flight plan. The SDP would be responsible for notifying the home or business owner when the package was delivered and picked up. Additionally, along with the postal address, the PAR's unique identifier may be stored in a database by the SDP for future use or to compare with previous requests and the use of multiple PAS at the same delivery address. The PAR manufacturer would be responsible for ensuring that each and every PAR has a unique identifier and that it's properly attached to the receptacle. The PAR manufacturer will be required to share the unique identifying with the purchaser at the time of PAR's receipt. The FAA and other government agencies like the USPS may include additional requirements for PAR like apparatuses within their UAS safely regulations.

1. Claim 1 states that an electronic signal can be transmitted with Beacon technology to direct an unmanned aerial vehicle (“UAV”) to a PAR's receptacle, the method comprising: under control of one or more computing systems configured with unique identification signal code, beacon, sending a unique code to the UAV for safely guiding UAV during the delivery process once the UAV reaches the postal address through approved flight plans; receiving signal from the PAR and confirm correct beacon identification signal to guide the UAV to a precise, user determined location to land on or hover over the PAR and drop off or retrieve packages at any USPS address.

2. Method of claim 1, further including sending PAR's unique identifier to the UAV by the Service Delivery Provider to the UAV to assist in the location of the PAR and assist in dropping and retrieving packages from the PAR's receptacle by the UAV.

3. Method of claim 1, further including providing PAR's unique identifier to the PAR owner by the PAR manufacturer.

4. Method of claim 1, further including providing the unique identifier to the Carrier Service Provider by the PAR owner.

5. Method of claim 1, further including transmitting (passive or active signal for the UAV to travel to the delivery platform.

6. Claim 2 states that the PAR apparatus will be constructed of fiberglass and plastic materials to avoid attracting electricity; be able to extend to a safe location away from the ground to avoid human interference.

7. Method of claim 2, further including that fiberglass and plastic material exists to for form and manufacture the PAR.

8. Method of claim 2, further including that mechanical devices exist to ground and extend and retract the PAR from electrical shock and at a distance to safely protect to reasonably prevent human interference.
